(19) United States
(12) Patent Application Publication
(10) Pub. No.: US 2023/0026522 A1
(43) Pub. Date: Jan. 26, 2023

(54) Fireproof and Waterproof Biomass Floor and Manufacturing Method Therefor

(71) Applicant: Jiangsu Kentier Wood Co., Ltd., Jiangsu (CN)

(72) Inventors: Haixing Li, Jiangsu (CN); Yiqun Fang, Jiangsu (CN); Junhua Zhang, Jiangsu (CN); Jianhong Xu, Jiangsu (CN)

(73) Assignee: Jiangsu Kentier Wood Co., Ltd., Jiangsu (CN)

(21) Appl. No.: 17/953,010

(22) Filed: Sep. 26, 2022

Related U.S. Application Data
(63) Continuation of application No. PCT/CN2020/090849, filed on May 18, 2020.

(30) Foreign Application Priority Data
Mar. 27, 2020 (CN) 202010228462.4

(51) Int. Cl. B27N 9/00; B27N 3/18; B27N 3/04; C08K 3/04; C08K 3/36; C08K 3/38; C08K 5/092

(52) U.S. Cl. CPC B27N 9/00; B27N 3/18; B27N 3/04; C08K 3/04; C08K 3/36; C08K 3/38; C08K 5/092; C08K 2003/325

(57) ABSTRACT

A fireproof and waterproof biomass floor and a manufacturing method therefor. The floor comprises, in parts by weight, 80-95 parts of a wood fiber, 5-20 parts of an additive, and 0-1 part of a pigment. The additive comprises the following raw material components in percentage by weight: a metal oxide: 10-20 wt %; a hydrochloride: 10-20 wt %; a non-metal oxide: 5-10 wt %; a weak acid: 5-10 wt %; a sulfate: 1-2 wt %; a phosphate: 1-2 wt %; and water: 36-68 wt %. The manufacturing method comprises: mixing the wood fiber, the additive, and the pigment; flatly laying the obtained mixture on a base plate; performing die pressing, and standing for 3-10 days; performing demolding; subjecting the obtained demolded plate to edge cutting, drying, sanding, assembling, hot pressing, cutting, curing, slotting, and silent pad pasting on the back face. The floor has the advantages of being fireproof, ultralow in water absorption thickness expansion rate, and ultralow in formaldehyde release amount.

### CROSS-REFERENCE TO RELATED APPLICATIONS

This application is a continuation of and claims priority to PCT International Patent Application No. PCT/CN2020/090849 filed May 18, 2020, which claims priority to Chinese Patent Application No. 202010228462.4 filed Mar. 27, 2020, the disclosures of which are incorporated herein by reference in their entireties.

### TECHNICAL FIELD

The present application relates to a floor and a manufacturing method therefor, and for example, to a fireproof and waterproof biomass floor and a manufacturing method therefor.

### BACKGROUND

At present, the floor can be classified by structure into: solid wood floors, reinforced composite wood floors, three-layer solid wood composite floors, bamboo and wood floors, anti-corrosion floors, cork floors, multi-layer solid wood composite floors which is the most popular one, etc.;

the floor can be classified by use into: household floors, business floors, anti-static floors, outdoor floors, special floors for stage dance, special floors for gyms, special floors for athletics, etc.; the floor can be classified by environmental protection grade into: E0 floors, E1 floors, F4 floors, F 4-star floors of Japanese Agricultural Standard (JAS) star standard, etc. Those floors has poor fireproof performance, and will accelerate the spread of fire when a fire breaks out;

those floors has poor waterproof performance, and it is easy to absorb water and deform in a humid environment; the floors contain formaldehyde, and the formaldehyde will be slowly released into the air from the floor; a common floor cannot has the three properties of fireproof performance, waterproof performance and low formaldehyde emission at the same time.

### SUMMARY

The summary of the subject detailed in this disclosure is described below. This summary is not intended to limit the protection scope of the claims.

Object of the application: a first object of the present application is to provide a fireproof and waterproof biomass floor which has fireproof performance, waterproof performance and ultra-low formaldehyde emission, and a second object of the present application is to provide a manufacturing method of the floor.

Technical solution: the fireproof and waterproof biomass floor of the present application includes, based on that a total weight of the floor is 100 parts, the following raw material components in parts by weight: 80-95 parts of a wood fiber, 5-20 parts of an additive and 0-1 part of a pigment; based on that a total weight of the additive is 100%, the additive includes the following raw material components in percentage by weight: 10-20 wt % of metal oxide, 10-20 wt % of hydrochloride, 5-10 wt % of non-metal oxide, 5-10 wt % of weak acid, 1-2 wt % of sulfate, 1-2 wt % of phosphate and 36-68 wt % of water.

Unless otherwise specified, the part in the present application refers to a part by weight, and the percentage refers to a percentage by weight.

The manufacturing method of the fireproof and waterproof biomass floor in the present application includes the following steps:
mixing a wood fiber, an additive and a pigment, spreading the prepared mixed material on a base plate, performing mold-pressing, and allowing the mixed material to stand for 3-10 days; performing demolding, and subjecting the demolded board to edge cutting, drying, sanding, assembly, hot-pressing, cutting, preservation, slotting, and mute pad bonding on the back face.

Furthermore, a drying temperature is more than or equal to 40° C., and the board is dried to a moisture content of less than or equal to 20 wt %.

Optionally, a fiber length of the wood fiber is 3-5 mm, the base plate is a smooth base plate made of strip steel or aluminum, a thickness of the base plate is 5-10 mm, and a thickness of the mixed material is 5-15 cm for spreading; the mold-pressing includes stacking the base plates, pressurizing to more than or equal to 25 MPa, and subjecting the base plates to pressurizing, tight locking and pressure holding; a 120 grit or finer sand belt is used to perform thickness-setting sanding, and the thickness deviation was within ±0.10 mm.

Optionally, a wear-resistant surface bond paper, a decorative bond paper, a fireproof and waterproof board, a balance bond paper are assembled in sequence; the assembled group is delivered to a press machine, a press of more than or equal to 2400t is used, which has 6 or more hydraulic cylinders, and each cylinder has a diameter of more than or equal to 420 mm, a temperature of the press is set at 140-200° C., a pressure of the press is set at more than or equal to 20 MPa, and a pressure-holding time is 30-300 s; the cutting includes cutting the large pressed board into pieces according to the required specification; the preservation includes allowing the small cut pieces to stand for a time that is more than or equal to 3 days and less than or equal to 10 days; the slotting includes slotting the pieces to form locks on the four sides, in which the lock on the short side is a vertical-hit lock; the mute pad is a cork pad or a polyvinyl chloride foam cushion pad.

The numerical range in the present application not only includes the exemplified point values, but also includes any point value of the numerical ranges which is not exemplified. Due to space limitations and in view of brevity, the specific point value included in the range will not be exhaustively listed in the present application.

Beneficial effects: compared with the prior art, the present application has the following prominent advantages: the floor of the present application has all the advantages at once including fireproof performance, ultra-low thickness swelling rate of water absorption and ultra-low formaldehyde emission; the flammability performance grade reaches A grade, the thickness swelling rate of water absorption is less than or equal to 1.90%, and the formaldehyde emission reaches the no-formaldehyde grade. The manufacturing method of the present application has simple operation, facilitating to large-scale production.

Other aspects will become apparent upon reading and understanding the detailed description.

### DETAILED DESCRIPTION

In an embodiment of the present application, the wood fiber can include any one or a combination of at least two of wood fibers derived from poplar, pine or straw, and the pigment includes activated carbon.

In an embodiment of the present application, the metal oxide can include any one or a combination of at least two of calcium oxide, magnesium oxide, zinc oxide or aluminum oxide.

In an embodiment of the present application, the hydrochloride can include any one or a combination of at least two of sodium chloride, calcium chloride, magnesium chloride or aluminum chloride.

In an embodiment of the present application, the non-metal oxide can include one or two of silicon dioxide or boron oxide.

In an embodiment of the present application, the weak acid can include any one or a combination of at least two of acetic acid, oxalic acid, citric acid, maleic acid, phosphoric acid or carbonic acid.

In an embodiment of the present application, the sulfate can include any one or a combination of at least two of sodium sulfate, calcium sulfate, aluminum sulfate or magnesium sulfate.

In an embodiment of the present application, the phosphate can include any one or a combination of at least two of calcium phosphate, magnesium phosphate, zinc phosphate or aluminum phosphate.

Technical solutions of the present application will be further described below in conjunction with the examples.

### Example 1

A floor manufacturing method of this example is as follows:

(1) Mixing and stirring materials: materials were mixed and stirred, including 80 parts of poplar, 0.5 part of activated carbon, 0.74 part of calcium oxide, 0.74 part of sodium chloride, 0.37 part of silicon dioxide, 0.37 part of acetic acid, 0.07 part of sodium sulfate, 0.07 part of calcium phosphate and 2.65 parts of water;
(2) Spreading the mixed material: the mixed material was spread evenly on a smooth base plate made of strip steel or aluminum, a size of the base plate was: 1200 mm*2600 mm, a thickness of the base plate was: 5 mm, and a thickness of the mixed material was 5 cm for spreading;
(3) Mold-pressing: fifty plates of the mixed material spread on the smooth base plate made of steel or aluminum were stacked and pressurized to 25 MPa, and those plates were pressurized, locked tightly and allowed to stand for 3 days with the pressure kept;
(4) Demolding and releasing a board: the board in the mold that had stood for 3 days was depressurized and demolded one by one;
(5) Trimming the board: the demolded board was subjected to edge cutting;
(6) Drying the board: the demolded board was placed into a drying room, a temperature of which was set to 40° C., dried to a moisture content of 20%, and a digital wood measuring meter (model PT-90E) was used;
(7) Sanding the board: a 120 grit sand belt was used to perform thickness-setting sanding, and the thickness deviation was within ±0.10 mm;
(8) Assembling materials: a wear-resistant surface bond paper, a decorative bond paper, a fireproof and waterproof board, a balance bond paper were assembled in sequence;
(9) Hot-pressing: the assembled group was delivered to a press machine; a 2400t press was used, which had 6 hydraulic cylinders, and each cylinder had a diameter of 420 mm, a temperature of the press was set at 140° C., a pressure of the press was set at 20 MPa, and a pressure-holding time was 30 min.;
(10) Cutting: the large pressed board was cut into pieces according to the required specification;
(11) Preservation: the small cut pieces were allowed to stand for 3 days;
(12) Slotting: the pieces were slotted to form locks on the four sides, and the lock on the short side was a vertical-hit lock;
(13) Bonding ethylene vinyl acetate (EVA) on the back face: a cork pad was bonded on the back face.

### Example 2

A floor manufacturing method of this example is as follows:

(1) Mixing and stirring materials: materials were mixed and stirred, including 87 parts of pine, 3.03 parts of magnesium oxide, 3.03 parts of calcium chloride, 1.62 parts of boron oxide, 1 part of oxalic acid, 0.62 part of citric acid, 0.30 part of calcium sulfate, 0.30 part of magnesium phosphate and 10.10 parts of water;
(2) Spreading the mixed material: the mixed material was spread evenly on a smooth base plate made of strip steel or aluminum, a size of the base plate was: 1200 mm*2600 mm, a thickness of the base plate was: 8 mm, and a thickness of the mixed material was 10 cm for spreading;
(3) Mold-pressing: fifty plates of the mixed material spread on the smooth base plate made of steel or aluminum were stacked and pressurized to 25 MPa, and those plates were pressurized, locked tightly and allowed to stand for 7 days with the pressure kept;
(4) Demolding and releasing a board: the board in the mold that had stood for 7 days was depressurized and demolded one by one;
(5) Trimming the board: the demolded board was subjected to edge cutting;
(6) Drying the board: the demolded board was placed into a drying room, a temperature of which was set to 40° C., dried to a moisture content of less than or equal to 20%, and a digital wood measuring meter (model PT-90E) was used;
(7) Sanding the board: a 120 grit sand belt was used to perform thickness-setting sanding, and the thickness deviation was within ±0.10 mm;
(8) Assembling materials: a wear-resistant surface bond paper, a decorative bond paper, a fireproof and waterproof board, a balance bond paper were assembled in sequence;
(9) Hot-pressing: the assembled group was delivered to a press machine; a 2400t press was used, which had 6 hydraulic cylinders, and each cylinder had a diameter of 420 mm, a temperature of the press was set at 170° C., a pressure of the press was set at 20 MPa, and a pressure-holding time was 100 s;
(10) Cutting: the large pressed board was cut into pieces according to the required specification;
(11) Preservation: the small cut pieces were allowed to stand for 7 days;
(12) Slotting: the pieces were slotted to form locks on the four sides, and the lock on the short side was a vertical-hit lock;
(13) Bonding EVA on the back face: a mute pad was bonded on the back face (a cork pad or a polyvinyl chloride foam cushion pad).

### Example 3

A floor manufacturing method of this example is as follows:

(1) Mixing and stirring materials: materials were mixed and stirred, including 95 parts of straw, 1 part of activated carbon, 1 part of zinc oxide, 0.52 part of aluminum oxide, 1 part of magnesium chloride, 0.52 part of aluminum chloride, 0.38 part of silicon dioxide, 0.38 part of boron oxide, 0.76 part of maleic acid, 0.07 part of aluminum sulfate, 0.08 part of magnesium sulfate, 0.07 part of zinc phosphate, 0.08 part of aluminum phosphate and 5.15 parts of water;
(2) Spreading the mixed material: the mixed material was spread evenly on a smooth base plate made of strip steel or aluminum, a size of the base plate was: 1200 mm*2600 mm, a thickness of the base plate was: 10 mm, and a thickness of the mixed material was 15 cm for spreading;
(3) Mold-pressing: fifty plates of the mixed material spread on the smooth base plate made of steel or aluminum were stacked and pressurized to 28 MPa, and those plates were pressurized, locked tightly and allowed to stand for 10 days with the pressure kept;
(4) Demolding and releasing a board: the board in the mold that had stood for 10 days was depressurized and demolded one by one;
(5) Trimming the board: the demolded board was subjected to edge cutting;
(6) Drying the board: the demolded board was placed into a drying room, a temperature of which was set to more than or equal to 40° C., dried to a moisture content of 10%, and a digital wood measuring meter (model PT-90E) was used;
(7) Sanding the board: a 130 grit sand belt was used to perform thickness-setting sanding, and the thickness deviation was within ±0.10 mm;
(8) Assembling materials: a wear-resistant surface bond paper, a decorative bond paper, a fireproof and waterproof board, a balance bond paper were assembled in sequence;
(9) Hot-pressing: the assembled group was delivered to a press machine; a 2450t press was used, which had 8 hydraulic cylinders, and each cylinder had a diameter of 450 mm, a temperature of the press was set at 200° C., a pressure of the press was set at 25 MPa, and a pressure-holding time was 300 s;
(10) Cutting: the large pressed board was cut into pieces according to the required specification;
(11) Preservation: the small cut pieces were allowed to stand for 10 days;
(12) Slotting: the pieces were slotted to form locks on the four sides, and the lock on the short side was a vertical-hit lock;
(13) Bonding EVA on the back face: a polyvinyl chloride foam cushion pad was bonded on the back face.

### Example 4

A floor manufacturing method of this example is as follows:

(1) Mixing and stirring materials: materials were mixed and stirred, including 80 parts of poplar, 0.5 part of activated carbon, 0.74 part of calcium oxide, 0.74 part of sodium chloride, 0.37 part of silicon dioxide, 0.18 part of phosphoric acid, 0.19 part of carbonic acid, 0.07 part of sodium sulfate, 0.07 part of calcium phosphate and 2.65 parts of water;
(2) Spreading the mixed material: the mixed material was spread evenly on a smooth base plate made of strip steel or aluminum, a size of the base plate was: 1200 mm*2600 mm, a thickness of the base plate was: 5 mm, and a thickness of the mixed material was 5 cm for spreading;
(3) Mold-pressing: fifty plates of the mixed material spread on the smooth base plate made of steel or aluminum were stacked and pressurized to 25 MPa, and those plates were pressurized, locked tightly and allowed to stand for 3 days with the pressure kept;
(4) Demolding and releasing a board: the board in the mold that had stood for 3 days was depressurized and demolded one by one;
(5) Trimming the board: the demolded board was subjected to edge cutting;
(6) Drying the board: the demolded board was placed into a drying room, a temperature of which was set to 40° C., dried to a moisture content of 20%, and a digital wood measuring meter (model PT-90E) was used;
(7) Sanding the board: a 120 grit sand belt was used to perform thickness-setting sanding, and the thickness deviation was within ±0.10 mm;
(8) Assembling materials: a wear-resistant surface bond paper, a decorative bond paper, a fireproof and waterproof board, a balance bond paper were assembled in sequence;
(9) Hot-pressing: the assembled group was delivered to a press machine; a 2400t press was used, which had 6 hydraulic cylinders, and each cylinder had a diameter of 420 mm, a temperature of the press was set at 140° C., a pressure of the press was set at 20 MPa, and a pressure-holding time was 30 min.;
(10) Cutting: the large pressed board was cut into pieces according to the required specification;
(11) Preservation: the small cut pieces were allowed to stand for 3 days;
(12) Slotting: the pieces were slotted to form locks on the four sides, and the lock on the short side was a vertical-hit lock;
(13) Bonding EVA on the back face: a cork pad was bonded on the back face.

### Comparative Example 1

In this comparative example, no metal oxide was added in the raw materials, and other raw materials, proportions, manufacturing steps and test methods were the same as those in Example 1.

### Comparative Example 2

In this comparative example, no hydrochloride was added, and other raw materials, proportions, manufacturing steps and test methods were the same as those in Example 1.

### Comparative Example 3

In this comparative example, no non-metal oxide was added, and other raw materials, proportions, manufacturing steps and test methods were the same as those in Example 1.

### Comparative Example 4

In this comparative example, no weak acid was added, and other raw materials, proportions, manufacturing steps and test methods were the same as those in Example 1.

### Comparative Example 5

In this comparative example, no sulfate was added, and other raw materials, proportions, manufacturing steps and test methods were the same as those in Example 1.

### Comparative Example 6

In this comparative example, no phosphate was added, and other raw materials, proportions, manufacturing steps and test methods were the same as those in Example 1.

### Comparative Example 7

In this comparative example, an amount of calcium oxide was 8 parts by weight, and other raw materials, proportions, manufacturing steps and test methods were the same as those in Example 1.

### Comparative Example 8

In this comparative example, an amount of calcium oxide was 22 parts by weight, and other raw materials, proportions, manufacturing steps and test methods were the same as those in Example 1.

### Comparative Example 9

In this comparative example, an amount of sodium chloride was 8 parts by weight, and other raw materials, proportions, manufacturing steps and test methods were the same as those in Example 1.

### Comparative Example 10

In this comparative example, an amount of sodium chloride was 22 parts by weight, and other raw materials, proportions, manufacturing steps and test methods were the same as those in Example 1.

### Comparative Example 11

In this comparative example, an amount of silicon dioxide was 4 parts by weight, and other raw materials, proportions, manufacturing steps and test methods were the same as those in Example 1.

### Comparative Example 12

In this comparative example, an amount of silicon dioxide was 11 parts by weight, and other raw materials, proportions, manufacturing steps and test methods were the same as those in Example 1.

### Comparative Example 13

In this comparative example, an amount of acetic acid was 4 parts by weight, and other raw materials, proportions, manufacturing steps and test methods were the same as those in Example 1.

### Comparative Example 14

In this comparative example, an amount of acetic acid was 11 parts by weight, and other raw materials, proportions, manufacturing steps and test methods were the same as those in Example 1.

### Comparative Example 15

In this comparative example, an amount of sodium sulfate was 0.5 part by weight, and other raw materials, proportions, manufacturing steps and test methods were the same as those in Example 1.

### Comparative Example 16

In this comparative example, an amount of sodium sulfate was 2.5 parts by weight, and other raw materials, proportions, manufacturing steps and test methods were the same as those in Example 1.

### Comparative Example 17

In this comparative example, an amount of calcium phosphate was 0.5 part by weight, and other raw materials, proportions, manufacturing steps and test methods were the same as those in Example 1.

### Comparative Example 18

In this comparative example, an amount of calcium phosphate was 2.5 parts by weight, and other raw materials, proportions, manufacturing steps and test methods were the same as those in Example 1.

The floor properties in Examples 1˜4 and Comparative Examples 1-18 are shown in Table 1, in which the test standard used for the fireproof performance test is GB8624-2012 (Classification for burning behavior of building materials and products).

Through the comparison of Comparative Examples 1-18 and Example 1, the fireproof performance in Comparative Examples 1-11 and 13-17 is not as good as that in Example 1, and the swelling rate of water absorption in Comparative Examples 8, 10, 14, 16 and 18 is much higher than that in Example 1, and the floors delaminated after immersed in water at 95° C. for 6 hours in Comparative Examples 8, 10, 14, 16 and 18.

TABLE 1
Floor properties in Examples 1-4 and Comparative Examples 1-28

| | | | | Thickness | | |
|---|---|---|---|---|---|---|
| | Fireproof Performance | | | Swelling Rate | | Immersion in |
| | | Flame | | of Water | Formaldehyde | Water at |
| | Incombustible | retardant | Combustible | Absorption | Emission | 95° C. for 6 |
| Name | (A) | (B1) | (B2) | (%) | (mg/m³) | hours |
| Example 1 | √ | x | x | 1.64 | No formaldehyde | No |
| | | | | | | delaminating |
| Example 2 | √ | x | x | 1.75 | No formaldehyde | No |
| | | | | | | delaminating |
| Example 3 | √ | x | x | 1.83 | No formaldehyde | No |
| | | | | | | delaminating |
| Example 4 | √ | x | x | 1.90 | No formaldehyde | No |
| | | | | | | delaminating |
| Comparative | x | x | √ | 1.50 | No formaldehyde | No |
| Example 1 | | | | | | delaminating |
| Comparative | x | √ | x | 1.60 | No formaldehyde | No |
| Example 2 | | | | | | delaminating |
| Comparative | x | x | √ | 1.71 | No formaldehyde | No |
| Example 3 | | | | | | delaminating |
| Comparative | x | √ | x | 1.52 | No formaldehyde | No |
| Example 4 | | | | | | delaminating |
| Comparative | x | √ | x | 1.57 | No formaldehyde | No |
| Example 5 | | | | | | delaminating |
| Comparative | x | √ | x | 1.54 | No formaldehyde | No |
| Example 6 | | | | | | delaminating |
| Comparative | x | x | √ | 1.58 | No formaldehyde | No |
| Example 7 | | | | | | delaminating |
| Comparative | x | √ | x | 6.82 | No formaldehyde | Delaminating |
| Example 8 | | | | | | |
| Comparative | x | x | √ | 1.62 | No formaldehyde | No |
| Example 9 | | | | | | delaminating |
| Comparative | x | x | √ | 4.32 | No formaldehyde | Delaminating |
| Example 10 | | | | | | |
| Comparative | x | √ | x | 1.66 | No formaldehyde | No |
| Example 11 | | | | | | delaminating |
| Comparative | √ | x | x | 1.49 | No formaldehyde | No |
| Example 12 | | | | | | delaminating |
| Comparative | x | √ | x | 1.72 | No formaldehyde | No |
| Example 13 | | | | | | delaminating |
| Comparative | x | √ | x | 4.16 | No formaldehyde | Delaminating |
| Example 14 | | | | | | |
| Comparative | x | √ | x | 1.70 | No formaldehyde | No |
| Example 15 | | | | | | delaminating |
| Comparative | x | √ | x | 4.06 | No formaldehyde | Delaminating |
| Example 16 | | | | | | |
| Comparative | x | √ | x | 1.61 | No formaldehyde | No |
| Example 17 | | | | | | delaminating |
| Comparative | √ | x | x | 5.24 | No formaldehyde | Delaminating |
| Example 18 | | | | | | |

As shown in the results in Table 1, it can be seen from the comparison of examples and comparative examples that, under the synergistic effect of the raw material components of the present application within a specific formula range, the floor of the present application has all the advantages at once including fireproof performance, ultra-low thickness swelling rate of water absorption and ultra-low formaldehyde emission; the flammability performance grade reaches A, the thickness swelling rate of water absorption is less than or equal to 1.90%, and the formaldehyde emission reaches the no-formaldehyde grade.

The specific embodiments described above describe the object, technical solutions and beneficial effects of the present application in detail, and it should be understood that the above embodiments are only specific embodiments of the present application and are not intended to limit the present application.

What is claimed is:

1. A fireproof and waterproof biomass floor, comprising, based on that a total weight of the floor is 100 parts, the following raw material components in parts by weight: 80-95 parts of a wood fiber, 5-20 parts of an additive and 0-1 part of a pigment; based on that a total weight of the additive is 100%, the additive comprises the following raw material components in percentage by weight: 10-20 wt % of metal oxide, 10-20 wt % of hydrochloride, 5-10 wt % of non-metal oxide, 5-10 wt % of weak acid, 1-2 wt % of sulfate, 1-2 wt % of phosphate and 36-68 wt % of water.

2. The fireproof and waterproof biomass floor according to claim 1, wherein the wood fiber comprises one of wood fibers derived from poplar, pine or straw, and the pigment comprises activated carbon.

3. The fireproof and waterproof biomass floor according to claim 1, wherein the metal oxide comprises one or more of calcium oxide, magnesium oxide, zinc oxide or aluminum oxide.

4. The fireproof and waterproof biomass floor according to claim 1, wherein the hydrochloride comprises one or more of sodium chloride, calcium chloride, magnesium chloride or aluminum chloride.

5. The fireproof and waterproof biomass floor according to claim 1, wherein the non-metal oxide comprises one or two of silicon dioxide and boron oxide.

6. The fireproof and waterproof biomass floor according to claim 1, wherein the weak acid comprises one or more of acetic acid, oxalic acid, citric acid, maleic acid, phosphoric acid or carbonic acid.

7. The fireproof and waterproof biomass floor according to claim 1, wherein the sulfate comprises one or more of sodium sulfate, calcium sulfate, aluminum sulfate or magnesium sulfate.

8. The fireproof and waterproof biomass floor according to claim 1, wherein the phosphate comprises one or more of calcium phosphate, magnesium phosphate, zinc phosphate or aluminum phosphate.

9. A manufacturing method of the fireproof and waterproof biomass floor according to claim 1, comprising the following steps:
mixing a wood fiber, an additive and a pigment, spreading the prepared mixed material on a base plate, performing mold-pressing, and allowing the mixed material to stand for 3-10 days; and
performing demolding, and subjecting the demolded board to edge cutting, drying, sanding, assembly, hot-pressing, cutting, preservation, slotting, and mute pad bonding on the back face.

10. The manufacturing method of the fireproof and waterproof biomass floor according to claim 9, wherein the drying comprises: drying the board to a moisture content of less than or equal to 20 wt % at a temperature of more than or equal to 40° C.
